(19) United States
(12) Patent Application Publication
(10) Pub. No.: US 2009/0161659 A1
(43) Pub. Date: Jun. 25, 2009

(54) ON-CHIP APPARATUS AND METHOD OF NETWORK CONTROLLING

(76) Inventors: Beom Hak LEE, Seoul (KR); Eui Seok Kim, Suwon-si (KR); Sangwoo Rhim, Yongin-si (KR); Beom Seok Shin, Suwon-si (KR)

Correspondence Address: MCNEELY BODENDORF LLP, P.O. BOX 34175, WASHINGTON, DC, 20043, US

(21) Appl. No.: 12/032,708

(22) Filed: Feb. 18, 2008

(30) Foreign Application Priority Data
Dec. 21, 2007 (KR) 10-2007-0096814

(51) Int. Cl. H04L 12/56

(52) U.S. Cl. 370/352

(57) ABSTRACT

An apparatus and method of controlling an on-chip network is provided. An apparatus for controlling a network includes an arbiter which generates a switch control signal based on first route information received from a first router, and a switch which receives from the first router a first data packet associated with the first route information, controls at least one output port according to the switch control signal during a first time interval, and outputs the first data packet via the at least one controlled output port during a second time interval.

### CROSS-REFERENCE TO RELATED APPLICATION

This application claims the benefit under 35 U.S.C. §119(a) of a Korean Patent Application No. 10-2007-0096814, filed on Sep. 21, 2007, in the Korean Intellectual Property Office, the entire disclosure of which is incorporated herein by reference.

### TECHNICAL FIELD

The following description relates to an apparatus and method of controlling a network using an on-chip router, and more particularly, to an apparatus and method of controlling a network that controls transmitting and receiving of data and an address between a plurality of intellectual properties (IPs) or a plurality of hardware accelerators.

### BACKGROUND

Developments in the field of circuit design and semiconductor fabrication technologies have made it possible to fabricate slim semiconductor chips. Therefore, a plurality of functional modules that have been implemented on individual chips can currently be integrated on one chip.

A technology that integrates the plurality of functional modules on one chip is referred as a System-on-Chip (SoC). Improvement of SoC technologies has realized convergence where computers, communications, broadcastings, and the like, are unified.

Also, due to development of SoC technologies, an application-specific integrated circuit (ASIC) and an application-specified standard product (ASSP) that have been fabricated on individual chips in the conventional art can be currently integrated into one chip.

In particular, a module that functions as a conventional ASIC or an ASSP in a SoC is referred to as an intellectual property (IP). More researches are being actively conducted regarding a process where the IP in the SoC performs functions that have been implemented on the conventional individual chips, and more particularly, regarding a scheme of connecting a plurality of IPs that is distributed on chips.

A bus-based connection scheme is generally used as a technology for connecting a plurality of IPs. However, in a bus-based architecture, if one IP is using a bus, the bus may be unavailable for other IPs. Therefore, as a number of IPs in the chip increases and an amount of information streams between IPs also increases, the SoC that uses the bus-based architecture where extensibility is not supported reaches the limit of its performance.

A Network on Chip (NoC) technology is additionally disclosed as a solution to solve the performance limitation of the SoC using the bus-based architecture. The NoC technology transforms a general network technology to be suitable for the SoC and thereby connects the plurality of IPs.

An example of the NoC technology includes a general network control scheme that controls the connection between IPs using a router.

Specifically, a plurality of IPs is connected to one router and the router controls transmission of data between the plurality of IPs in a network. Also, the router sets a route of a data packet or a flit.

However, the use of the router increases latency when data transmitted in a form of a packet or a flit passes through the router. When the number of routers via which a data packet or a data flit has to pass through during a transmission process increases, it increases latency between an IP of a source and a destination.

To decrease the latency, the conventional art offers a scheme which can greatly increase a number of IPs connected to one router and thereby decrease the number of routers in the network. However, in this case, when a plurality of IPs is connected to one router, an arbiter and a switch fabric becomes complex in the network.

Accordingly, there is a need for a new method and apparatus which can decrease latency between IPs, without increasing the network complexity.

### SUMMARY

In one aspect, there is provided a method of controlling a network which decreases latency between intellectual properties (IPs) without increasing the network complexity.

In another aspect, there is provided a method of controlling a network which improves data transmitting/receiving performance in a network without an additional component of hardware.

In still another aspect, there is provided a method of controlling a network which improves a data transmitting/receiving performance in a network, without including a prediction process for a data transmission route. The prediction process for the data transmission route may be excluded and thus no penalty is incurred when a prediction of the data transmission route fails. Accordingly, it is possible to stably minimize latency when transmitting and receiving data between a plurality of IPs.

In yet another aspect, an apparatus for controlling a network includes: an arbiter which generates a switch control signal based on first route information received from a first router; and a switch which receives from the first router a first data packet associated with the first route information, controls at least one output port according to the switch control signal during a first time interval, and outputs the first data packet via the at least one controlled output port during a second time interval.

In still yet another aspect, a network system includes: a first router; and a second router which receives route information from the first router during a first time interval to open a route based on the route information, and receives from the first router a data packet associated with the route information during a second time interval to transmit the data packet via the open route.

In still yet another, a method of controlling a network includes: receiving first route information from a first router; determining an output port of a second router based on the received first route information; opening the determined output port; and transmitting to a third router a first data packet associated with the received first route information, via the open output port.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a diagram illustrating an operation of a network system according to an exemplary embodiment.

FIG. 2 is a diagram illustrating an operation of a network system according to another exemplary embodiment.

FIG. 3 is a diagram illustrating an operation of a network system according to still another exemplary embodiment.

FIG. 4 is a diagram illustrating an exemplary router.

FIG. 5 is a diagram illustrating another exemplary router.

FIG. 6 is a diagram illustrating a network system according to yet another exemplary embodiment.

FIG. 7 is a diagram illustrating a second router shown in FIG. 6, in detail.

FIG. 8 is a diagram illustrating a concatenated arbitration scheme of the arbiter shown in FIG. 7.

FIG. 9 is a diagram illustrating a switch shown in FIG. 7, in detail.

FIG. 10 is a flowchart illustrating an exemplary method of controlling a network.

FIG. 11 is a flowchart illustrating another exemplary method of controlling a network.

Throughout the drawings and the detailed description, the same drawing reference numerals will be understood to refer to the same elements, features, and structures.

### DETAILED DESCRIPTION

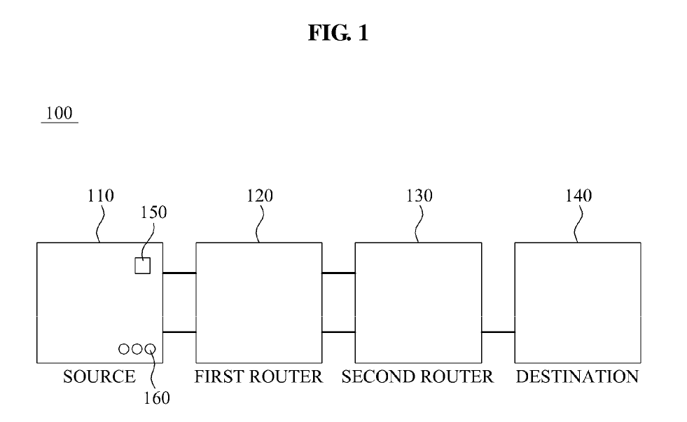

The following detailed description is provided to assist the reader in gaining a comprehensive understanding of the methods and systems described herein. Accordingly, various changes, modifications, and equivalents of the systems and methods described herein will be suggested to those of ordinary skill in the art. Also, descriptions of well-known functions and constructions are omitted to increase clarity and conciseness. FIG. 1 illustrates an operation of a network system 100 according to an exemplary embodiment.

Referring to FIG. 1, the network system 100 includes a source 110, a first router 120, a second router 130, and a destination 140.

As shown in FIG. 1, route information 150 and a data packet 160 are in a standby state for transmission in the source 110.

The route information 150 and the data packet 160 are transmitted from the source 110 to the destination 140.

The route information 150 includes information about the source 110 and the destination 140 of the data packet 160.

The source 110 searches for the first router 120 to transmit the data packet 160 based on the route information 150.

When the first router 120 is found, the source 110 transmits the route information 150 to the first router 120.

After the route information 150 is generated, the source 110 performs capsulation of the data packet 160.

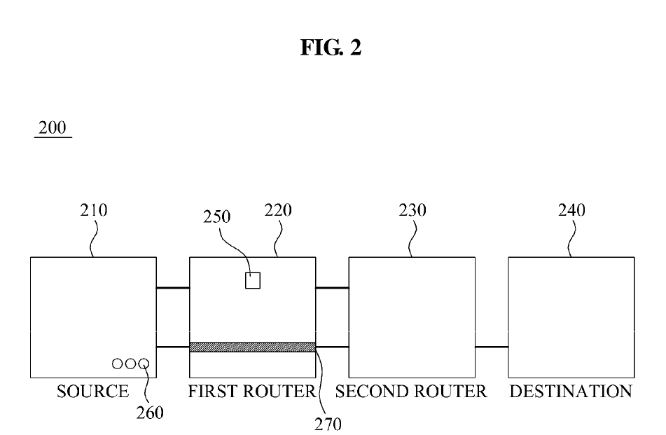

FIG. 2 illustrates an operation of a network system 200 according to another exemplary embodiment.

Referring to FIG. 2, the network system 200 includes a source 210, a first router 220, a second router 230, and a destination 240.

As shown in FIG. 2, the first router 220 has received route information 250 from the source 210.

The route information 250 includes information about the source 210 and the destination 240 of the data packet 260.

The first router 220 searches for the second router 230 to transmit the data packet 260 based on the received route information 250.

The first router 220 opens a route 270 to the found second router 230.

The first router 220 transmits the route information 250 to the second router 230, and the source 210 transmits the data packet 260 to the first router 220.

The second router 230 receives the route information 250 and subsequently transmits to the first router 220 an acknowledgment signal (ACK) corresponding to the route information 250.

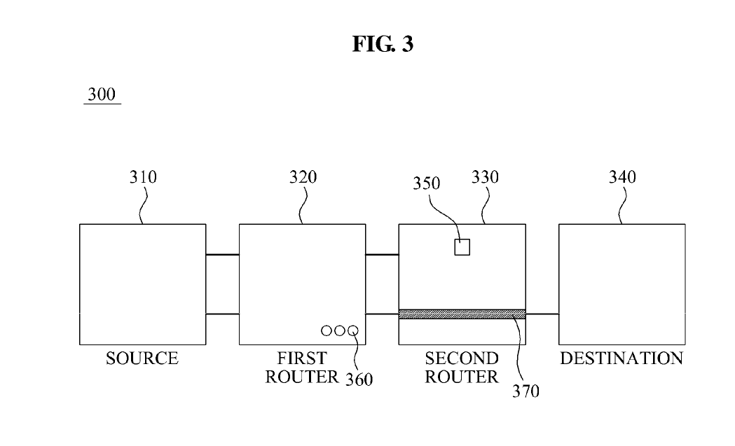

FIG. 3 illustrates an operation of a network system 300 according to still another exemplary embodiment.

Referring to FIG. 3, the network system 300 includes a source 310, a first router 320, a second router 330, and a destination 340.

As shown in FIG. 3, the second router 330 has received route information 350 from the first router 320, and the first router 320 has received a data packet 360 from the source 310.

The route information 350 includes information about the source 310 and the destination 340 of the data packet 360.

The second router 330 searches for the destination 340 based on the route information 350. The second router 330 opens a route 370 to the found destination 340.

The first router 320 transmits the data packet 360 to the second router 330. The data packet 360 is transmitted to the destination 340 via the opened route 370 of the second router 330.

The second router 330 receives the route information 350 prior to receiving the data packet 360, and opens the route 370 to transmit the data packet 360 based on the received route information 350.

After the route 370 is opened, the data packet 360 is transmitted to the second router 330. The data packet 360 is transmitted to the destination 340 via the opened route 370, which results in reducing a transmission time of the data packet 360.

Each of components in the network system 300 initially receives the route information 350 of the data packet 360 at least one clock before receiving the data packet 360. Accordingly, each of the components in the network system 300 computes a route of the data packet 360 before receiving the data packet 360, opens the route, and thereby reduces the transmission time of the data packet 360.

When a router of a general network system receives a data packet and route information, a route is computed, a switch of the router is set, the data packet traverses the set switch, and the router transmits the data packet.

When the data packet traverses N routers, N times the sum of route computation time, switch allocation time, switch traversal time, and data packet transmission time is required. In this instance, the data packet transmission time denotes time that is spent to transmit the data packet from one router to another router.

In a network system according to an exemplary embodiment, route information is transmitted prior to a data packet being transmitted, and computation of a route and allocation of a switch is performed in advance. Therefore, when the data packet traverses N routers, the route computation time, the switch allocation time, and the switch traversal time is not required for an on-the-way router. Accordingly, in the exemplary network system, it is possible to greatly reduce a time for transmitting and receiving data even when the data packet traverses a plurality of routers.

As an attempt to reduce the entire processing time when a data packet traverses a plurality of routers, a scheme of predicting a route of the data packet and opening the predicted route before arrival of the data packet is disclosed in “A Delay Model and Speculative Architecture for Pipelined Routers” that was published in Proceedings of the 7th International Symposium on High-Performance Computer Architecture, Jan. 22-24, 2001, by W. J. Dally et al.

A prediction scheme for a route of a data packet may include a prediction scheme based on a previous travel route of the data packet. However, in the case of the scheme of predicting the route of the data packet and opening the predicted route, when the predication of the route is incorrect, the route of the data packet must be recomputed and a switch also must be reallocated depending on results of the recomputation. In this instance, the time that is spent to recompute the route and reallocated the switch is a penalty that is incurred when the predication of the route is incorrect.

However, in a network system according to the present invention, a route of a data packet is not predicted and instead, route information is received in advance to compute the route. Therefore, no penalty is incurred.

As another attempt to reduce the entire processing time when a data packet traverses a plurality of routers, disclosed is “Express Cube: Improving the Performance of k-ary n-cube Interconnection Network”, in IEEE transaction on computers, September 1991, by W. J. Dally et al. The attempt is to assign a highway of a data packet between particular routers and thereby reduce the data transmission time.

However, the above scheme of assigning the highway of the data packet needs an additional component of hardware, which results in increasing the complexity of hardware.

Conversely, a network system according to the present invention does not need an additional component of hardware, which results in reducing a processing time for transmitting and receiving a data packet.

In the network system 300 according to the present exemplary embodiment, the source 310 and the destination 340 are not fixed and thus may be relatively chosen during a data packet transmission process.

For example, when the data packet is transmitted from the destination 340 to the source 310, operations of the first router 320 and the second router 330 may be switched.

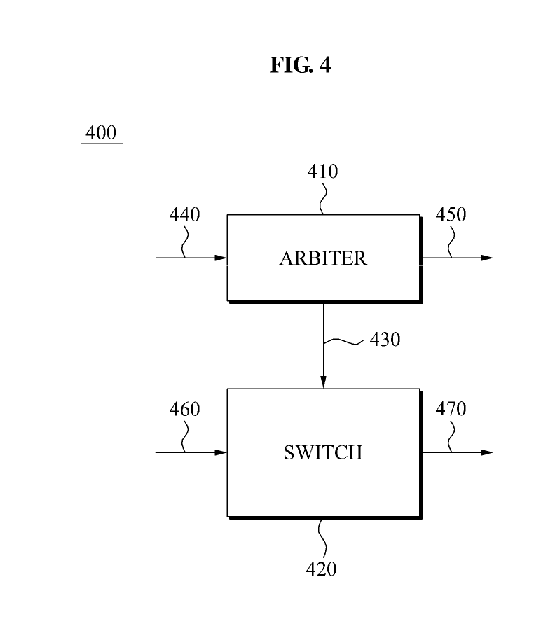

FIG. 4 illustrates an exemplary router 400.

Referring to FIG. 4, the router 400 includes an arbiter 410 and a switch 420.

The arbiter 410 generates a switch control signal 430 based on first route information 440 received from a first router.

The arbiter 410 computes a route of a first data packet 460 based on the received first route information 440 and generates second route information 450. Also, the arbiter 410 transmits the generated second route information 450 to a second router.

The arbiter 410 transmits the second route information 450 to the second router during a first time interval.

The first router transmits the first route information 440 to the router 400 and subsequently transmits the first data packet 460 to the router 400.

The switch 420 receives from the first router the first data packet 460 associated with the first route information 440.

The switch 420 includes at least one output port. The switch 420 controls the at least output port according to the switch control signal 430 during the first time interval.

The switch 420 outputs the routed first data packet 470 via the controlled at least one output port during a second time interval.

The switch 420 outputs the first data packet 470 to the second router via the controlled at least one output port.

The switch 420 receives the first data packet 460 during the first time interval or the second time interval.

The switch 420 is generally referred to as a crossbar switch. The crossbar switch functions to switch a connection between a plurality of input/output ports.

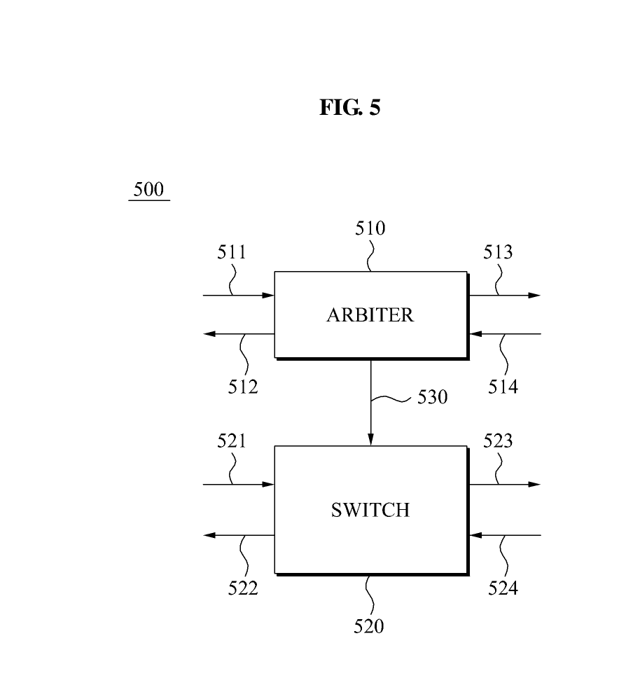

FIG. 5 illustrates another exemplary router 500.

Referring to FIG. 5, the router 500 includes an arbiter 510 and a switch 520.

The arbiter 510 generates a switch control signal 530 based on first route information 511 received from a first router.

The arbiter 510 computes a route of a transmitted first data packet 521 based on the received first route information 511 and generates second route information 513. Also, the arbiter 510 transmits the generated second route information 513 to a second router.

The first router transmits the first route information 511 to the router 500 and subsequently transmits the first data packet 521 to the router 500.

The arbiter 510 receives the first route information 511 and subsequently transmits to the first router an ACK 512 corresponding to the first route information 511.

The switch 520 receives from the first router the transmitted first data packet 521 associated with the first route information 511.

The switch 520 includes at least one output port. The switch 520 controls the at least one output port according to the switch control signal 530 during the first time interval.

The switch 520 outputs the routed first data packet 523 via the controlled at least one output port during a second time interval.

The switch 520 outputs the routed first data packet 523 to the second router via the controlled at least one output port.

The switch 520 receives the transmitted first data packet 521, and subsequently transmits to the first router an ACK 522 corresponding to the transmitted first data packet 521.

The second router receives the second route information 513 and subsequently transmits to the arbiter 510 an ACK 514 corresponding to the second route information 513.

The arbiter 510 transmits the second route information 513 and subsequently receives from the second router the ACK 514 corresponding to the second route information 513.

The second router receives the routed first data packet 523 and subsequently transmits to the switch 520 an ACK 524 corresponding to the routed first data packet 523.

The switch 520 transmits the routed first data packet 523 and subsequently receives from the second router an ACK 524 corresponding to the routed first data packet 523.

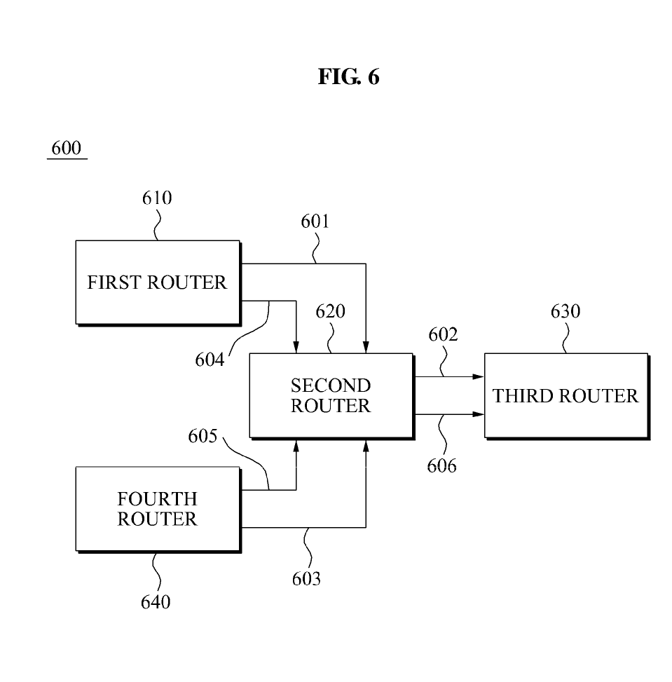

FIG. 6 illustrates a network system 600 according to yet another exemplary embodiment.

Referring to FIG. 6, the network system 600 includes a first router 610, a second router 620, a third router 630, and a fourth router 640.

The first router 610 transmits to the second router 620 first route information 601 associated with a first data packet 604.

The fourth router 640 transmits to the second router 620 second route information 603 associated with a second data packet 605.

When the second router 620 receives the first route information 601 and the second route information 603 during the same time interval, the second router 620 selects as prior route information route information that has a higher priority between the first route information 601 and the second route information 603. If the first route information is selected as the prior route information, the second router 620 computes a route of the first data packet 604 associated with the first route information 601 and searches for a router to transmit the first data packet 604.

If the found router is the third router 630, the second router 620 transmits to the third router 630 via a route information transmission channel 602, the first route information 601 that is selected as the prior route information.

The second router 620 transmits to the first router 610 an ACK corresponding to the first route information 601.

The ACK corresponding to the first route information 601 indicates that the second router 620 has received the first route information 601 and also that the second router 620 is ready to receive the first packet data 604.

The first router 610 receives the ACK corresponding to the first route information 601 and subsequently transmits the first data packet 604 to the second router 620.

The second router 620 transmits the first route information 601 to the third router 630 via the route information transmission channel 602, and subsequently transmits the first data packet 604 to the third router 630 via a data packet transmission channel 606.

The second router 620 transmits the first route information 601 to the third router 630, and subsequently computes a path of the second data packet 605 associated with the second route information 603, and searches for a router to transmit the second data packet 605.

If the found router is the third router 630, the second router 620 transmits the second route information 603 to the third router 630 via the route information transmission channel 602.

The second router 620 transmits to the fourth router 640 an ACK corresponding to the second route information 603.

The ACK corresponding to the second route information 603 indicates that the second router 620 has received the second route information 603 and also that the second router 620 is ready to receive the second data packet 605.

The fourth router 640 receives from the second router 620 the ACK corresponding to the second route information 603, and subsequently transmits the second data packet 605 to the second router 620.

The second router 620 transmits the second route information 603 to the third router 630 via the route information transmission channel 602, and subsequently transmits the second data packet 605 to the third router 630 via the data packet transmission channel 606.

Depending on embodiments, the second router 620 simultaneously transmits the routed second route information to the third router 630 via the route information transmission channel 602 and the routed first data packet to the third router 630 via the data packet transmission channel 606.

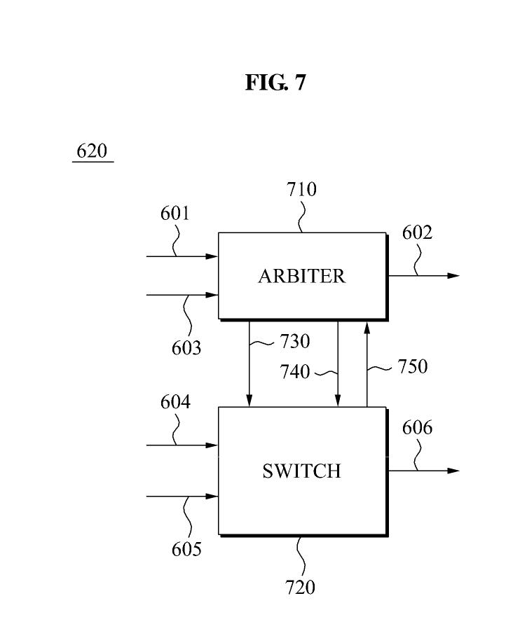

FIG. 7 illustrates the second router 620 shown in FIG. 6, in detail.

Referring to FIG. 7, the second router 620 includes an arbiter 710 and a switch 720.

The arbiter 710 receives the first route information 601 from the first router 610 and receives the second route information 603 from the fourth router 640.

The switch 720 receives the first data packet 604 from the first router 610 and receives the second data packet 605 from the fourth router 640.

The switch 720 includes a plurality of input ports that receives a plurality of data packets from a plurality of routers. In this instance, the plurality of data packets includes the first data packet 604 and the second data packet 605, and the plurality of routers includes the first router 610 and the fourth router 640.

The switch 720 includes a plurality of output ports that transmits the plurality of data packets via a plurality of data packet transmission channels. In this instance, the plurality of data packets includes the first data packet 604 and the second data packet 605. Also, the plurality of data packet channels is connected to the plurality of routers including the third router 630, and includes the data packet transmission channel 606.

The arbiter 710 generates a first switch control signal 730 to control the plurality of input ports of the switch 720 and a second switch control signal 740 to control the plurality of output ports of the switch 720.

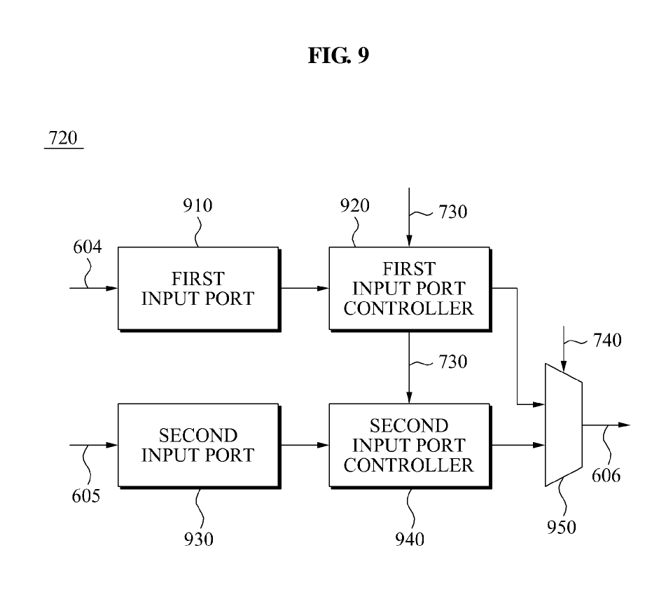

The process of controlling the switch 720 using the first switch control signal 730 and the second switch control signal 740 will be described with reference to FIG. 9.

Referring again to FIG. 7, the arbiter 710 selects as prior route information route information that has a higher priority between the first route information 601 and the second route information 603.

The arbiter 710 generates the first switch control signal 730 and the second switch control signal 740 based on the prior route information.

If the first route information 601 is selected as the prior route information as in the assumption of FIG. 6, the arbiter 710 computes a route of the first data packet 604 associated with the first route information 601 and searches for a router to transmit the first data packet 604.

If the found router is the third router 630 as in the assumption of FIG. 6, the arbiter 710 transmits to the third router 630 via the route information transmission channel 602 the first route information 601 that is selected as the prior route information.

Depending on embodiments, the arbiter 710 may compute the route of the first data packet 604 based on the first route information 601 and generate third route information in which results of the computation are reflected. The third route information includes route information associated with the first data packet 604. In this instance, the arbiter 710 transmits the third route information to the third router 630 via the route information transmission channel 602.

The arbiter 710 stores the second route information 603 that is not selected as the prior route information. The arbiter 710 may include a memory to store the second route information 603.

The arbiter 710 transmits to the first router 610 an ACK corresponding to the first route information 601.

The arbiter 710 transmits the first route information 601 to the third router 630 and subsequently transmits the received first data packet 604 to the third router 630 via the data packet transmission channel 606.

The switch 720 controls the input ports and the output ports according to the generated first switch control signal 730 and the second switch control signal 740 and thereby opens the input ports and the output ports connected to the data packet transmission channel 606.

The first switch control signal 730 and the second switch control signal 740 are generated based on the first route information 601 and thus include information about a route connected to the third router 630. In this instance, the third router 630 is in an ensuing route that the first data packet passes through. Therefore, the first switch control signal 730 and the second switch control signal 740 also include information about the data packet transmission channel 606 connected to the third router 630.

The first switch control signal 730 and the second switch control signal 740 control the switch 720 to open an input port and an output port connected to the data packet transmission channel 606 among the plurality of input ports and the plurality of output ports of the switch 720.

When the transmission of the first data packet 604 is completed, the switch 720 generates a completion signal 750 and transmits the generated completion signal 750 to the arbiter 710.

The arbiter 710 transmits the first route information 601 to the third router 630, and subsequently computes a route of the second data packet 605 associated with the second route information 603 and searches for a router to transmit the second data packet 605.

If the found router is also the third router 630 as in the assumption of FIG. 6, the arbiter 710 transmits the second route information 603 to the third router 630 via the route information transmission channel 602.

Depending on embodiments, the arbiter 710 may compute the route of the second data packet 605 based on the second route information 603 and generate fourth route information in which results of the computation are reflected. The fourth route information includes route information associated with the second data packet 605. In this instance, the arbiter 710 transmits the fourth route information to the third router 630 via the route information transmission channel 602.

The arbiter 710 may transmit the second route information 603 to the third router 630 and subsequently remove the stored second route information from the memory.

The arbiter 710 transmits to the fourth router 640 an ACK corresponding to the second route information 603.

After the arbiter 710 transmits the second route information 603 to the third router 630, the switch 720 transmits the received second data packet 605 to the third router 630 via the data packet transmission channel 606.

Depending on embodiments, when the arbiter 710 stores the second route information 603 and in this state, additionally receives fifth route information from a fifth router(not shown), the arbiter 710 compares priorities of the stored second route information 603 and the received fifth route information. The arbiter 710 may select as new prior route information route information that has higher priority between the stored second route information 603 and the received fifth route information, and store in the memory route information having a lower priority.

The arbiter 710 does not wait for the completion signal 750 that is generated by the switch 720. When the transmission of the first route information 601 to the third router 630 is completed, the arbiter 710 transmits the second route information 603 to the third router 630.

The third router 630 may receive the first route information 601 prior to receiving the first data packet 604, and computes the path of the first data packet 604 in advance based on the first route information 601.

When the transmission of the first route information 601 is completed and the second route information 603 is transmitted to the third router 630, the arbiter 710 may receive the second route information 603 before receiving the second data packet 605. Also, the third router 630 may compute the path of the second data packet 605 in advance, based on the second route information 603.

Generally, when arbitrating the priority between route information or data packets, an arbiter may use a fixed priority arbitration scheme, a round-robin arbitration scheme, a first-in first-out (FIFO) arbitration scheme, and the like.

The fixed priority arbitration scheme denotes a scheme that performs arbitration so that a data packet received from the first router 610 may be fixably prior to another data packet received from the fourth router 640 when the data packets are simultaneously received from the first router 610 and the fourth router 640.

The round-robin arbitration scheme denotes a scheme that, in one turn, performs arbitration so that the data packet received from the first router 610 may be prior to the other data packet received from the fourth router 640 and, in another turn, performs arbitration so that the other data packet received from the fourth router 640 may be prior to the data packet received from the first router 610 when the data packets are simultaneously received from the first router 610 and the fourth router 640.

The FIFO arbitration scheme denotes a scheme that performs arbitration so that a priorly received data packet may have a higher priority when the data packets are simultaneously received from the first router 610 and the fourth router 640.

The arbiter 710 may perform arbitration with respect to the higher priority between route information or data packets using an architecture of concatenating a plurality of arbitration schemes.

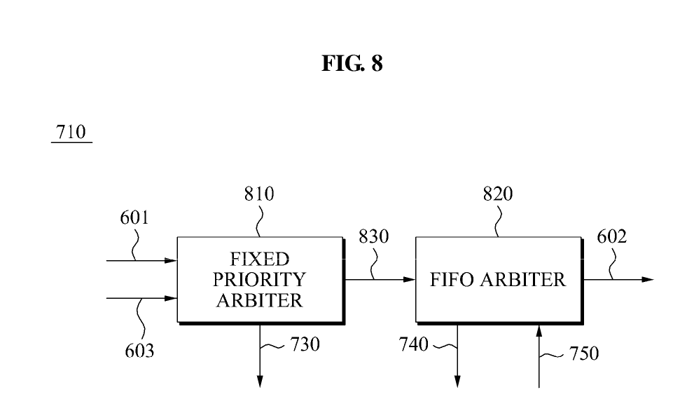

FIG. 8 illustrates the concatenated arbitration scheme of the arbiter 710 shown in FIG. 7.

Referring to FIG. 8, the arbiter 710 includes a fixed priority arbiter 810 and a FIFO arbiter 820.

The fixed priority arbiter 810 receives the first route information 601 from the first router 610 and receives the second route information 603 from the fourth router 640.

The fixed priority arbiter 810 generates the first switch control signal 730 that controls input ports of the switch 720.

The fixed priority arbiter 810 fixably selects the first route information 601 as prior route information when the fixed priority arbiter receives the first route information 601 and the second route information 603 during the same time interval.

The fixed priority arbiter 810 fixably assigns a higher priority to the first router 610 between the first router 610 and the fourth router 640 and thereby performs arbitration so that the first route information 601 received from the first router 610 may always be prior to the second route information 603 received from the fourth router 640.

The fixed priority arbiter 810 generates the first switch control signal 730 based on the first route information 601 and transmits the first route information 601 to the FIFO arbiter 820 via an internal route 830.

The FIFO arbiter 820 stores the first route information 601 and generates the second switch control signal 740 based on the first route information 601. The FIFO arbiter 820 transmits the stored first route information 601 to the third router 630 via the route information transmission channel 602.

The FIFO arbiter 820 verifies whether the output port of the switch 720 is transmitting a data packet. As a result of the verification, when the output port of the switch 720 is not transmitting the data packet, the FIFO arbiter 820 transmits the second switch control signal 740 to the switch 720.

When the transmission of the first route information 601 to the FIFO arbiter 820 is completed, the fixed priority arbiter 810 additionally generates the first switch control signal 730 based on the second route information 603 and transmits the second route information 603 to the FIFO arbiter 820 via the internal route 830.

The FIFO arbiter 820 stores the second route information 603 and additionally generates the second switch control signal 740 based on the second route information 603. The FIFO arbiter 820 transmits the stored second route information 603 to the third router 630 via the route information transmission channel 602.

The FIFO arbiter 820 verifies whether the output port of the switch 720 is transmitting a data packet. As a result of the verification, when the output port of the switch 720 is not transmitting the data packet, the FIFO arbiter 820 transmits the additionally generated second switch control signal 740 to the switch 720. Conversely, when the output port of the switch 720 is transmitting the first data packet 604, the FIFO arbiter 820 receives the completion signal 750 from the switch 720 and subsequently transmits the additionally generated second switch control signal 740 to the switch 720.

The FIFO arbiter 820 may include a FIFO memory. The FIFO memory stores the first route information when the FIFO arbiter 820 receives the first route information 601, and stores the second route information 603 when the FIFO arbiter 820 receives the second route information 603.

When operations associated with the first route information 601 are completed, the first route information 601 is removed from the FIFO memory. In this instance, the operations include generation of the second switch control signal 740 based on the first route information 601 and transmission of the first route information 601 to the third router 630.

When the first route information 601 is removed from the FIFO memory, the FIFO arbiter 820 receives the second route information 603 from the FIFO memory.

Also, when operations associated with the second route information 603 are completed, the second route information 603 is removed from the FIFO memory. In this instance, the operations include generation of the additional second switch control signal 740 based on the second route information 603 and transmission of the third router 630 to the second route information 603.

FIG. 9 illustrates the switch 720 shown in FIG. 7, in detail.

Referring to FIG. 9, the switch 720 includes an architecture corresponding to the concatenated arbitration scheme shown in the arbiter 710 of FIG. 8.

The switch 720 includes a first input port 910, a first input port controller 920, a second input port 930, a second input port controller 940, and a multiplexer 950.

The first input port 910 receives the first data packet 604 from the first router 610.

The second input port 930 receives the second data packet 605 from the fourth router 640.

The first input port controller 920 stores the first data packet 604 received by the first input port 910.

The first input port controller 920 may include a FIFO memory. When the first input port 910 receives a data packet from the first router 610 and also receives another data packet from a fifth router, the FIFO memory stores the data packets in a received order. Also, the FIFO memory transmits the stored data packets to the output port in the stored order.

The first input port controller 920 is controlled by the first switch control signal 730.

The first switch control signal 730 is generated based on the first route information 601 or the second route information 603. The first input port controller 920 identifies which route information the first switch control signal 730 is generated based on between the first route information 601 and the second route information 603. The first input port controller 920 determines whether to transmit the first data packet to the output port depending on results of the identification.

The second input port controller 940 stores the second data packet 605 received by the second input port 930.

The second input port controller 940 is controlled by the first switch control signal 730.

The second input port controller 940 identifies which route information the first switch control signal 730 is generated based on between the first route information 601 and the second route information 603. The second input port controller 940 determines whether to transmit the second data packet to the output port depending on results of the identification.

The multiplexer 950 selects one of either the output of the first input port controller 920 and the output of the second input port controller 940, and transmits the data packet to the selected output via the data packet transmission channel 606.

The multiplexer 950 selects one of either the output of the first input port controller 920 and the output of the second input port controller 940, based on the second switch control signal 740.

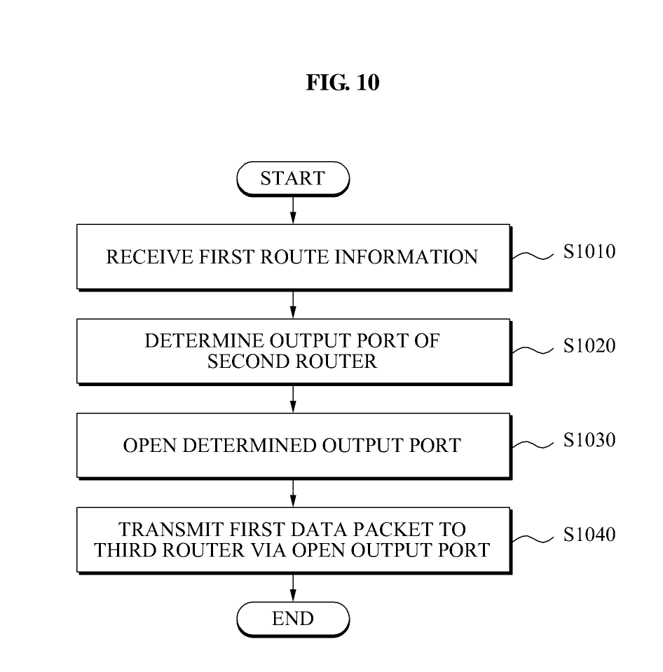

FIG. 10 illustrates an exemplary method of controlling a network.

Referring to FIG. 10, in operation S1010, the network control method receives first route information from a first router.

In operation S1020, the network control method determines an output port of a second router based on the received first route information.

In operation S1030, the network control method opens the determined output port.

In operation S1040, the network control method transmits to a third router a first data packet associated with the received first route information, via the open output port.

The network control method may receive from the first router the first data packet associated with the first route information after completing operation S1020.

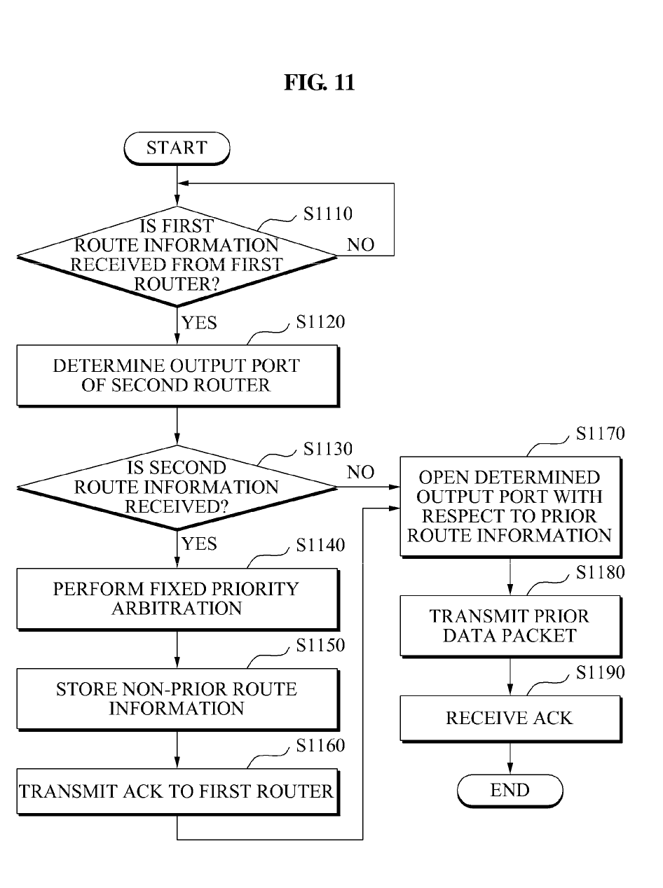

FIG. 11 illustrates another exemplary method of controlling a network.

Referring to FIG. 11, in operation S1110, the network control method verifies whether first route information is received from a first router.

When the first route information is not received, operation S1110 is repeated.

Conversely, when the first route information is received, the network control method determines an output port of a second router based on the received first route information in operation S1120.

In operation S1130, the network control method verifies whether the second route information is received from a fourth router.

When the second route information is received, the network control method performs arbitration with respect to the first route information and the second route information using a fixed priority arbitration scheme in operation S1140.

Also, in operation S1140, the network control method generates prior route information having a higher priority between the first route information and the second route information.

Also, in operation S1140, the network control method may fixably select the first route information as the prior route information.

In operation S1150, the network control method stores non-prior route information that is not selected as the prior route information between the first route information and the second route information.

In operation S1160, the network control method transmits to the first router an ACK corresponding to the received first route information.

In operation S1170, the network control method opens an output port that is determined with respect to the prior route information.

Conversely, when the second route information is not received in operation SI 130, operation S1170 is performed.

In operation S1180, the network control method transmits a prior data packet via the open output port.

The network control method may further include receiving the first data packet from the first router and receiving the second data packet from the fourth router.

In operation S1180, the network control method may generate the prior data packet associated with the prior route information.

Also, in operation S1180, the network control method may select as the prior data packet a data packet that is associated with the prior route information between the first data packet and the second data packet.

Also, in operation S1180, the network control method may transmit the generated data packet to the third router via the open output port.

In this instance, since the first route information is fixably selected as the prior route information with respect to the second route information, the first data packet is selected as the prior data packet.

In operation S1190, the network control method receives from the third router the ACK corresponding to the first data packet.

Depending on embodiments, the network control method may perform arbitration with respect to the first route information and the second route information using the FIFO arbitration scheme, instead of the fixed priority arbitration scheme. In this instance, the network control method determines the output port of the second router between the first route information and the second route information according to route information received in advance.

Depending on embodiments, the network control method may compute third route information based on the received first route information.

In this instance, the network control method transmits the computed third route information to the third router.

The above-described method including network control methods may be recorded, stored, or fixed in one or more computer-readable media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. The media may also be a transmission medium such as optical or metallic lines, wave guides, and the like including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations and methods described above.

According to certain embodiments described above, there is provided a method of controlling a network which may decrease latency between IPs without increasing the network complexity. There is also provided a method of controlling a network which may improve data transmitting/receiving performance in a network without using an additional component of hardware. Moreover, there is provided a method of controlling a network which may improve a data transmitting/receiving performance in a network, without including a prediction process for a data transmission route. The prediction process for the data transmission route may be excluded and thus no penalty is incurred when a prediction of the data transmission route fails. Accordingly, it is possible to stably minimize latency when transmitting and receiving data between a plurality of IPs.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for controlling a network, comprising:
an arbiter which generates a switch control signal based on first route information received from a first router; and
a switch which receives from the first router a first data packet associated with the first route information, controls at least one output port according to the switch control signal during a first time interval, and outputs the first data packet via the at least one controlled output port during a second time interval.

2. The apparatus of claim 1, wherein the arbiter computes a route of the first data packet based on the received first route information to generate second route information, and transmits the generated second route information to a second router, and the switch outputs the first data packet to the second router.

3. The apparatus of claim 2, wherein the arbiter transmits the second route information to the second router during the first time interval.

4. The apparatus of claim 1, wherein the switch receives the first data packet during the first time interval or the second time interval.

5. The apparatus of claim 1, wherein the arbiter receives the first route information and subsequently transmits to the first router an acknowledgment signal corresponding to the first route information.

6. The apparatus of claim 1, wherein the arbiter receives third route information from a third router, and generates the switch control signal based on prior path information having a higher priority between the first route information and the third route information.

7. The apparatus of claim 6, wherein the arbiter comprises:
a fixed priority arbiter which fixably selects the first route information as the prior route information.

8. The apparatus of claim 6, wherein the arbiter comprises:
a first-in first-out (FIFO) arbiter which stores the first route information and the third route information, and selects, as the prior route information, route information that is first received between the first route information and the third route information.

9. The apparatus of claim 1, wherein the switch receives the first data packet from the first router, and the switch comprises:
at least one input port which receives a second data packet from a third router; and
at least one switching controller which respectively controls the at least one input port to transfer to the at least one output port one of either the first data packet and the second data packet.

10. The apparatus of claim 9, wherein each of the at least one input port comprises:
a FIFO memory which stores the received first data packet and the second data packet, and transfers to the at least one output port a data packet that is first stored between the first data packet and the second data packet.

11. The apparatus of claim 9, wherein the at least one switching controller comprises:
a multiplexer which is connected to the at least one input port and the at least one output port, and controlled according to the switch control signal.

12. A network system comprising:
a first router; and
a second router which receives route information from the first router during a first time interval to open a route based on the route information, and receives from the first router a data packet associated with the route information during a second time interval to transmit the data packet via the open route.

13. The network system of claim 12, wherein the first router transmits the route information to the second router and subsequently transmits the data packet to the second router.

14. The network system of claim 12, wherein the second router receives the route information and subsequently transmits to the first router an acknowledgment signal corresponding to the route information.

15. A method of controlling a network, comprising:
receiving first route information from a first router;
determining an output port of a second router based on the received first route information;
opening the determined output port; and
transmitting to a third router a first data packet associated with the received first route information, via the open output port.

16. The method of claim 15, further comprising:
transmitting to the first router an acknowledgment signal corresponding to the received first route information.

17. The method of claim 15, further comprising:
receiving second route information from a fourth router; and
generating prior route information having a higher priority between the first route information and the second route information,
wherein the determining determines the output port of the second router based on the prior route information.

18. The method of claim 17, wherein the generating fixably selects the first route information as the prior route information.

19. The method of claim 17, wherein the generating stores non-prior route information that is not selected as the prior route information between the first route information and the second route information.

20. The method of claim 17, further comprising:
receiving the first data packet from the first router;
receiving the second data packet from the fourth router;
generating a prior data packet associated with the prior route information between the first data packet and the second data packet; and
transmitting the prior data packet to the determined output port of the second router.

21. The method of claim 15, further comprising:
receiving second route information from the fourth router,
wherein the determining determines the output port of the second router based on route information that is first received between the received first route information and the second route information.

22. The method of claim 15, further comprising:
computing third route information based on the received first route information; and
transmitting the computed third route information to the third router.

23. The method of claim 15, further comprising:
receiving from the third router an acknowledgment signal corresponding to the transmitted first data packet.

24. The method of claim 15, further comprising:
receiving the first data packet from the first router after determining the output port of the second router.

25. A computer-readable recording medium storing a program for implementing a method of controlling a network, comprising:
receiving first route information from a first router;
determining an output port of a second router based on the received first route information;
opening the determined output port; and
transmitting to a third router a first data packet associated with the received first route information, via the open output port.
